(19) United States
(12) Patent Application Publication
(10) Pub. No.: US 2026/0057854 A1
(43) Pub. Date: Feb. 26, 2026

(54) LIQUID CRYSTAL DISPLAY DEVICE

(71) Applicant: Sharp Display Technology Corporation, Kameyama City (JP)

(72) Inventor: Hiroshi MATSUKIZONO, Kameyama City (JP)

(21) Appl. No.: 19/270,783

(22) Filed: Jul. 16, 2025

(30) Foreign Application Priority Data
Aug. 22, 2024 (JP) 2024-140799

(51) Int. Cl. G09G 3/36; G09G 3/34

(52) U.S. Cl. CPC G09G 3/3648; G09G 3/3406; G09G 2320/0257; G09G 2320/064; G09G 2330/021; G09G 2330/027

(57) ABSTRACT

A liquid crystal display device includes a liquid crystal panel, a lighting device, and a control unit. The liquid crystal panel includes a TFT. The control unit executes a writing process of writing an image based on a video signal to the liquid crystal panel by applying a positive gate voltage to the TFT, a retention process of, in a state where a negative gate voltage is applied to the TFT, retaining the image written to the liquid crystal panel by the writing process, a specific process of, at a predetermined timing, continuously applying the positive gate voltage to the TFT and then finishing applying the positive gate voltage, and a specific turn-on driving process of, during execution of the specific process, driving the lighting device to glow at least in a predetermined period of time during which the positive gate voltage is continuously applied to the TFT.

### CROSS-REFERENCE TO RELATED APPLICATIONS

The present disclosure contains subject matter related to that disclosed in Japanese Priority Patent Application JP 2024-140799 filed in the Japan Patent Office on Aug. 22, 2024, the entire contents of which are hereby incorporated by reference.

### BACKGROUND

### 1. Field

The present disclosure relates to a liquid crystal display device.

### 2. Description of the Related Art

As an example of a liquid crystal display device having transistors made from an oxide semiconductor, a liquid crystal display device described in Japanese Unexamined Patent Application Publication No. 2018-185516 has been known. This liquid crystal display device illustrates an example in which an In—Ga—Zn oxide semiconductor (IGZO) or other oxide semiconductors are used as a semiconductor material for thin-film transistors (hereinafter referred to as “TFTs”) that drive each separate pixel of the liquid crystal display device. It is known that hydrogen or moisture contained in an oxide semiconductor constituting a TFT causes a threshold voltage of the TFT to undergo a change in a minus direction (negative direction) (i.e. causes a negative shift in threshold). The liquid crystal display device reduces intrusion of moisture into the oxide semiconductor by placing, between a seal member that seals in liquid crystals and the TFT, an area of contact between a first insulating film and a third insulating film constituting the TFT. This is said to reduce a negative shift in threshold of a TFT made from an In—Ga—Zn oxide semiconductor (IGZO) as the oxide semiconductor.

Of light from a backlight device of the liquid crystal display device, light repeatedly reflected inside the TFT without being reflected by a gate electrode of the TFT is herein referred to as “stray light”. The oxide semiconductor TFT incorporated into the liquid crystal display device has a negative gate voltage applied to the oxide semiconductor TFT in a waiting state that occupies a large portion of a conducting period of the liquid crystal display device, and is retained in a state of continuously receiving photoirradiation with the stray light based on the light from the backlight device. The stray light causes an electron-hole pair to be generated in the oxide semiconductor, and a hole of the electron-hole pair thus generated is attracted to a negative potential of the gate electrode. Accordingly, the hole is trapped at an interface between the oxide semiconductor and a gate insulating layer, so that there occurs a shift in threshold voltage of the TFT in a minus direction (i.e. a negative shift in threshold). Meanwhile, it is known that even if there occurs such a negative shift in threshold, applying a positive gate voltage to the oxide semiconductor TFT and subjecting the oxide semiconductor TFT to photoirradiation with the stray light causes the threshold voltage of the TFT to undergo a change in a plus direction (positive direction) toward an initial value that it assumed before the negative shift in threshold had occurred (i.e. causes a positive shift in threshold). Japanese Unexamined Patent Application Publication No. 2018-185516 fails to disclose such recovery of a threshold voltage.

It is desirable to provide a liquid crystal display device that makes it possible to positively shift, in a timely manner, a threshold of a TFT subjected to a negative shift in threshold.

### SUMMARY

According to an aspect of the disclosure, there is provided a liquid crystal display device including a liquid crystal panel, a lighting device that illuminates the liquid crystal panel with light from behind, and a control unit that controls driving of the liquid crystal panel and driving of the lighting device. The liquid crystal panel includes a TFT including a semiconductor layer containing an oxide semiconductor. The control unit executes a writing process of writing an image based on a video signal to the liquid crystal panel by applying a positive gate voltage to the TFT, a retention process of, in a state where a negative gate voltage is applied to the TFT, retaining the image written to the liquid crystal panel by the writing process, a specific process of, at a predetermined timing, continuously applying the positive gate voltage to the TFT and then finishing applying the positive gate voltage, and a specific turn-on driving process of, during execution of the specific process, driving the lighting device to glow at least in a predetermined period of time during which the positive gate voltage is continuously applied to the TFT.

### BRIEF DESCRIPTION OF THE DRAWINGS

FIG. 1 is an exploded perspective view of a liquid crystal display device according to a first embodiment;

FIG. 2 is a circuit diagram showing a pixel array in a display area of an array substrate of a liquid crystal panel constituting the liquid crystal display device;

FIG. 3 is a cross-sectional view of LEDs, an LED substrate, and a reflective sheet of a backlight device constituting the liquid crystal display device;

FIG. 4 is a cross-sectional view of a TFT of the array substrate;

FIG. 5 is an explanatory diagram showing details of a writing process and a retention process during low-frequency driving and high-frequency driving of the TFT and details of a specific process and a specific turn-on driving process;

FIG. 6 is a block diagram showing an electric configuration of the liquid crystal display device;

FIG. 7 is a flow chart of a specific process execution determination process;

FIG. 8 is an explanatory diagram explaining a status of use of a PC mounted with a liquid crystal display device according to a second embodiment;

FIG. 9 is a block diagram showing reception of a status-of-use signal by a control unit of the liquid crystal display device; and

FIG. 10 is a flow chart of a luminance determination process.

### DESCRIPTION OF THE EMBODIMENTS

The following enumerates embodiments of the present disclosure first.
(1) According to an aspect of the disclosure, there is provided a liquid crystal display device including a liquid crystal panel, a lighting device that illuminates the liquid crystal panel with light from behind, and a control unit that controls driving of the liquid crystal panel and driving of the lighting device. The liquid crystal panel includes a TFT including a semiconductor layer containing an oxide semiconductor. The control unit executes a writing process of writing an image based on a video signal to the liquid crystal panel by applying a positive gate voltage to the TFT, a retention process of, in a state where a negative gate voltage is applied to the TFT, retaining the image written to the liquid crystal panel by the writing process, a specific process of, at a predetermined timing, continuously applying the positive gate voltage to the TFT and then finishing applying the positive gate voltage, and a specific turn-on driving process of, during execution of the specific process, driving the lighting device to glow at least in a predetermined period of time during which the positive gate voltage is continuously applied to the TFT.

By executing the retention process after the writing process has been performed, the control unit of the liquid crystal display device according to the present disclosure can retain the image written to the liquid crystal panel by the writing process. This allows the liquid crystal display device to, in displaying a still image or other images, reduce the power consumption of the liquid crystal display device by reducing the frequency of execution of the writing process. Note here that when the TFT is kept in a state of continuously receiving photoirradiation with the stray light based on the light from the lighting device in a state where the negative gate voltage is applied to the TFT, there undesirably occurs a negative shift in threshold, i.e. a shift in threshold voltage of the TFT in a minus direction. Meanwhile, it is known that even if there occurs such a negative shift in threshold, applying the positive gate voltage to the TFT and subjecting the TFT to photoirradiation with the stray light causes the threshold voltage of the TFT to undergo a change in a plus direction (positive direction) toward an initial value that it assumed before the negative shift in threshold had occurred (i.e. causes a positive shift in threshold). The liquid crystal display device according to the present disclosure is configured such that during execution of the specific process, the lighting device is driven by the specific turn-on driving process to glow at least in a predetermined period of time during which the positive gate voltage is continuously applied to the TFT. For this reason, the TFT to which the positive gate voltage is being applied receives photoirradiation with the stray light, whereby a positive shift in threshold of the TFT can be made. Accordingly, the liquid crystal display device according to the present disclosure can positively shift, in a timely manner, a threshold of the TFT subjected to a negative shift in threshold.
(2) In the liquid crystal display device according to (1), the control unit may execute the specific process and the specific turn-on driving process in powering off the liquid crystal display device.

In this case, the control unit executes the specific process and the specific turn-on driving process in powering off the liquid crystal display device. This makes it possible to, without hindering the user of the liquid crystal display device by a user, recover the threshold of the TFT subjected to the negative shift in threshold.
(3) In the liquid crystal display device according to (1) or (2), the control unit may be able to execute both high-frequency driving in which the writing process and the retention process are repeated at high frequencies and low-frequency driving in which a frequency of execution of the writing process is lower than it is in the high-frequency driving and, in a case where a period of duration of execution of the low-frequency driving is longer than or equal to a predetermined length of time, may execute the specific process and the specific turn-on driving process.

The case where the execution of the low-frequency driving continues for the predetermined length of time or longer is a situation where there tends to occur a negative shift in threshold of the TFT. Further, the case where the execution of the low-frequency driving continues for the predetermined length of time or longer is considered to be a situation where the user is not actively using the liquid crystal display device. By executing the specific process and the specific turn-on driving process in such a case, the control unit can positively shift, in a timely manner, the threshold of the TFT subjected to the negative shift in threshold.
(4) In the liquid crystal display device according to any of (1) to (3), the control unit may cause the lighting device to be lower in luminance during the specific turn-on driving process than it is in a case where the writing process and the retention process are executed.

The case where the writing process and the retention process are executed is a situation where the image based on the video signal is written to the liquid crystal panel. In such a case, the control unit drives the lighting device to glow at such a predetermined luminance that viewability of the image is maintained. Meanwhile, in the specific turn-on driving process, the lighting device needs only be driven to glow at such a luminance that the TFT to which the positive gate voltage is being applied is subjected to a positive shift in threshold. Accordingly, the control unit may cause the lighting device to be lower in luminance during the specific turn-on driving process than it is in a case where the writing process and the retention process are executed. This makes it possible to reduce power consumption in positively shifting the threshold of the TFT subjected to the negative shift in threshold. This also makes it possible to avoid giving the user a feeling of incongruity by driving the lighting device to glow through the specific turn-on driving process.
(5) In the liquid crystal display device according to any of (1) to (4), the control unit may determine a luminance of the lighting device during the specific turn-on driving process according to a result of a judgment made on a status of use of the liquid crystal display device.

The liquid crystal display device is used in various situations. The control unit determines the luminance of the lighting device in the specific turn-on driving process according to various statuses of use of the liquid crystal display device, and executes the specific turn-on driving process at the luminance thus determined. Accordingly, the liquid crystal display device makes it possible to avoid giving the user a feeling of incongruity by driving the lighting device to glow through the specific turn-on driving process.
(6) In the liquid crystal display device according to any of (1) to (5), the semiconductor layer of the TFT may contain an In—Ga—Zn oxide semiconductor.

In a case where the semiconductor layer of the TFT contains an In—Ga—Zn oxide semiconductor, the low-frequency driving, in which the frequency of execution of the writing process is lower than it is in the high-frequency driving, tends to become predominant over the high-frequency driving, in which the writing process and the retention process are repeated at high frequencies. This makes it easy to cause a negative shift in threshold of the TFT. The control unit of the liquid crystal display device, which executes the specific process and the specific turn-on driving process in a case where such a TFT is employed, can appropriately positively shift the threshold of the TFT subjected to the negative shift in threshold.

### Details of First Embodiment of the Present Disclosure

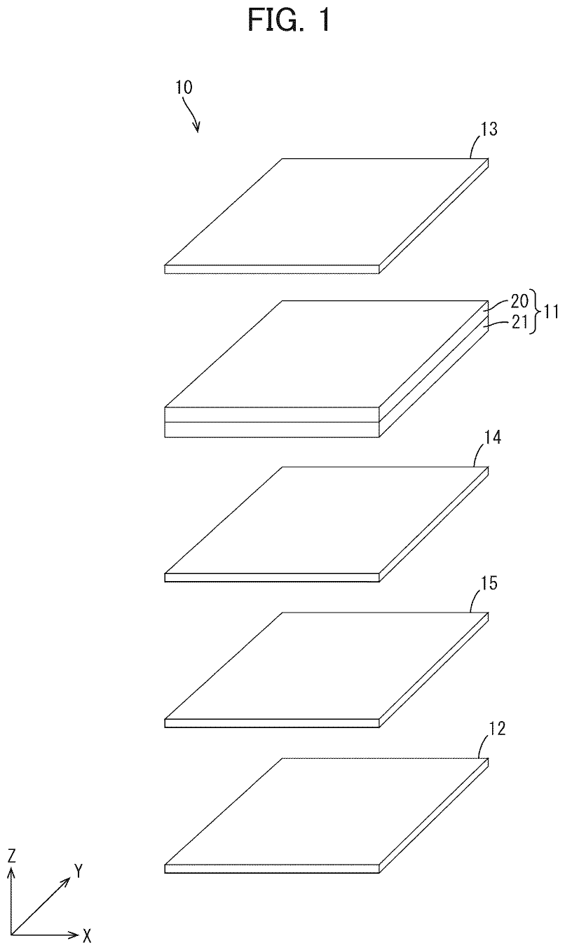

A first embodiment of the present disclosure is described with reference to FIGS. 1 to 7. A liquid crystal display device 10 is illustrated herein. Note that some of the drawings show an X axis, a Y axis, and a Z axis and are drawn so that the direction of each axis is an identical direction in each drawing. Further, FIGS. 1, 3, and 4 show front side up and back side down.

As shown in FIG. 1, the liquid crystal display device 10 includes a liquid crystal panel 11, a backlight device 12 placed at the back (behind) the liquid crystal panel 11, a pair of polarizing plates 13 and 14 between which the liquid crystal panel 11 is sandwiched, and an optical member 15 placed at the front (in front of) the backlight device 12. The backlight device 12 is an example of a lighting device. The liquid crystal panel 11 is capable of displaying a picture (image) through the use of light emitted by the backlight device 12.

Configurations of the liquid crystal panel 11 and the backlight device 12 are described. First, as shown in FIG. 1, the liquid crystal panel 11 has at least a pair of substrates 20 and 21. One of the pair of substrates 20 and 21 that is in front of the other is a counter substrate 20, and one of the pair of substrates 20 and 21 that is behind the other is an array substrate 21. A liquid crystal layer is sandwiched between the pair of substrates 20 and 21. The counter substrate 20 and the array substrate 21 are each obtained by forming a stack of various types of films on an inner surface of a glass substrate. The counter substrate 20 is provided with color filters of R (red), G (green), B (blue), or other colors and a light-blocking portion (black matrix) that partitions adjacent ones of the color filters from one another, or other components. The liquid crystal layer contains liquid crystal molecules constituting a substance whose optical properties vary in the presence of the application of an electric field. An alignment film for aligning the liquid crystal molecules contained in the liquid crystal layer is provided on the innermost surface of the counter substrate 20. A seal portion that seals in the liquid crystal layer is sandwiched between the outer edges of the pair of substrates 20 and 21.

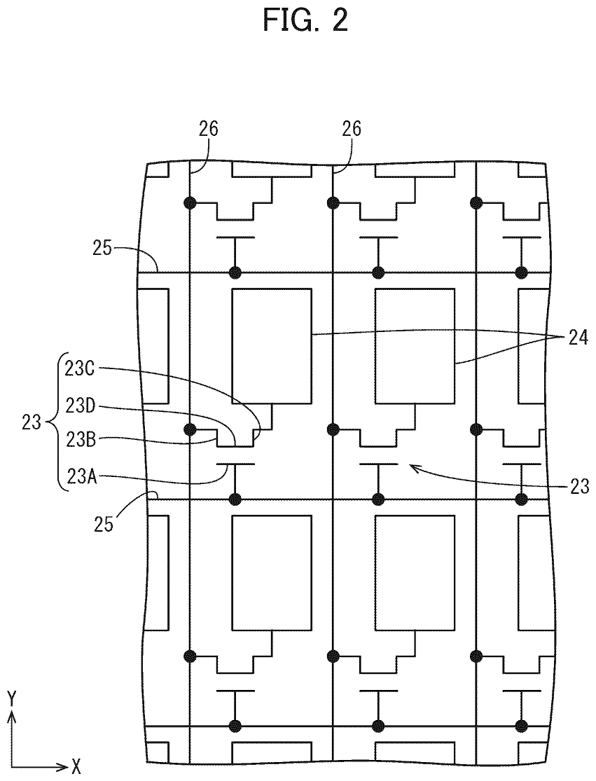

As shown in FIG. 2, the array substrate 21 has at least a TFT (thin-film transistor, switching element) 23 and a pixel electrode 24 provided on the inner surface thereof. A plurality of the TFTs 23 and a plurality of the pixel electrodes 24 are placed at spacings along the X-axis direction and the Y-axis direction and arranged in a matrix (rows and columns). Disposed around these TFTs 23 and these pixel electrodes 24 are a gate line (scanning line) 25 and a source line (image line, signal line) 26 that are orthogonal to (intersect) each other. The gate line 25 extends along the X-axis direction, and a plurality of the gate lines 25 are placed at spacings in the Y-axis direction. The source line 26 extends along the Y-axis direction, and a plurality of the source lines 26 are placed at spacings in the X-axis direction.

The TFT 23 has a gate electrode 23A connected to the gate line 25, a source electrode 23B connected to the source line 26, a drain electrode 23C connected to the pixel electrode 24, and a semiconductor layer 23D connected to the source electrode 23B and the drain electrode 23C and made from a semiconductor material. The TFT 23 is an active element having a function of applying a voltage to the gate electrode 23A, controlling an electric current flowing through the semiconductor layer 23D, and switching an electric current between the source electrode 23B and the drain electrode 23C. Specifically, the TFT 23 is driven in accordance with a scanning signal that is supplied to the gate electrode 23A by the gate line 25. Then, a potential pertaining to an image signal (data signal) that is supplied to the source electrode 23B by the source line 26 is supplied to the drain electrode 23C via the semiconductor layer 23D. As a result of that, the pixel electrode 24 is charged with the potential pertaining to the image signal.

The pixel electrode 24 is placed in an area surrounded by the gate line 25 and the source line 26 and is substantially rectangular in planar shape.

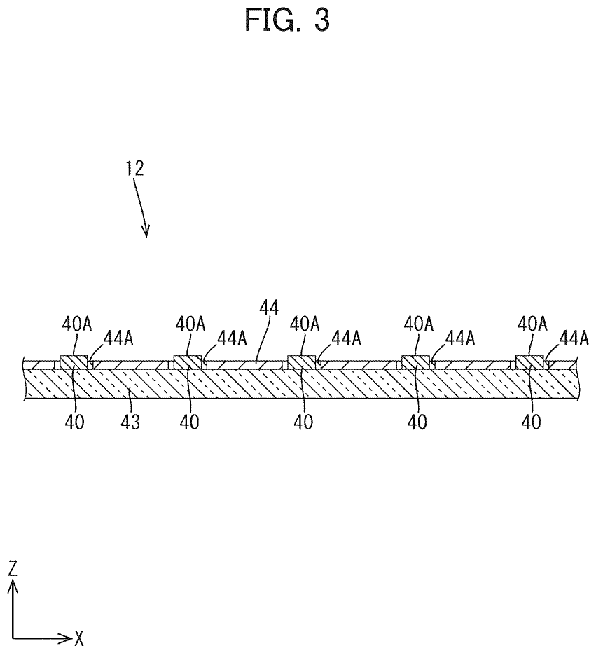

The following describes the configuration of the backlight device 12. As shown in FIG. 3, the backlight device 12 includes at least a plurality of LEDs 40 serving as light sources, an LED substrate 43 provided with the plurality of LEDs 40, and a reflective sheet 44. The backlight device 12 is of a so-called direct-lit type.

Each of the LEDs 40 is constituted by an LED chip sealed by a sealant onto a base member mounted on the LED substrate 43. The LED 40 is, for example, a blue LED that monochromatically emits blue light. The sealant of the LED 40 has phosphors dispersedly blended therewith. The phosphors contained in the sealant include a yellow phosphor, a green phosphor, and a red phosphor. The LED 40, which includes such an LED chip and such a sealant, emits white light as a whole. The LED 40 is of a so-called top-emission type in which a light-emitting surface 40A faces away from the LED substrate 43.

As shown in FIG. 3, the LED substrate 43 is placed in such a position that a mounting surface on which the LEDs 40 are mounted faces forward. On the mounting surface of the LED substrate 43, the LEDs 40 are planarly placed at spacings. The reflective sheet 44 is made of synthetic resin and has a highly reflective white or silver surface. The reflective sheet 44 is stacked in such a manner as to cover substantially the entire area of the mounting surface of the LED substrate 43 from the front and has bored therethrough a plurality of insert holes 44A, formed in such positions as to overlap the LEDs 40, through each of which the LEDs 40 are passed individually. The reflective sheet 44 can cause light emitted by the LEDs 40 or other rays of light to be reflected forward.

As shown in FIG. 1, the optical member 15 has the shape of a plate or a sheet having a principal surface that is parallel to a principal surface of the liquid crystal panel 11 and a principal surface of the LED substrate 43 of the backlight device 12. The optical member 15 is composed of one or more plate-like members or sheet-like members. The optical member 15 is disposed to be sandwiched between the liquid crystal panel 11 and the backlight device 12 in the Z-axis direction and has a function of, for example, imparting a predetermined optical effect to light emitted by the backlight device 12 and, at the same time, causing the light to be emitted toward the liquid crystal panel 11. Examples of the optical member 15 include a diffuser panel, a prism sheet, a diffusion sheet, and a wavelength conversion sheet.

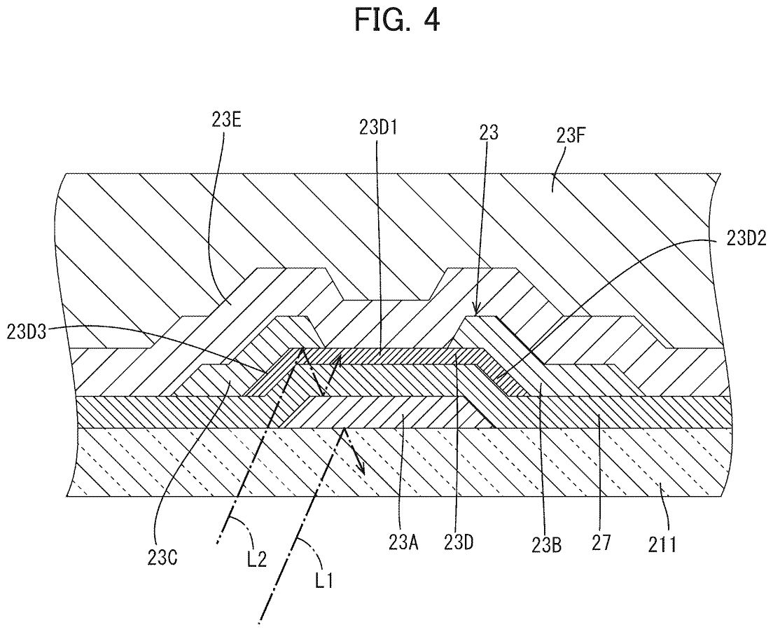

A configuration of the TFT 23 is described in detail. As shown in FIG. 4, the TFT 23 includes the gate electrode 23A, a gate insulating film 27, the semiconductor layer 23D, the source electrode 23B, and the drain electrode 23C. The gate electrode 23A is formed on top of a glass substrate 211 constituting the array substrate 21. The gate insulating film 27 covers the gate electrode 23A. The semiconductor layer 23D is formed on top of the gate insulating film 27. The semiconductor layer 23D has a channel region 23D1, a source contact region 23D2 placed on one side of the channel region 23D1, and a drain contact region 23D3 placed on the other side of the channel region 23D1. The channel region 23D1 overlaps the gate electrode 23A via the gate insulating film 27. The source contact region 23D2 is a region connected to the source electrode 23B, and the source electrode 23B is placed on top of the source contact region 23D2. The drain contact region 23D3 is a region connected to the drain electrode 23C, and the drain electrode 23C is placed on top of the drain contact region 23D3. On top of the TFT 23, a passivation film 23E and an organic insulating film 23F are further provided for the prevention of influence from an external environment and adherence of contaminants.

In the present embodiment, the semiconductor layer 23D is composed almost exclusively of an oxide semiconductor. The term “almost exclusively” refers to a component that is contained in the largest amount of constituent components of which the semiconductor layer 23D is composed. Although the oxide semiconductor may be either amorphous or crystalline, it is preferable that an amorphous oxide semiconductor be used. A reason for this is that a semiconductor film composed of an oxide semiconductor is much higher in charge mobility than a semiconductor film of amorphous silicon and can be driven with a low voltage.

The semiconductor layer 23D of the present embodiment is composed almost exclusively of an In—Ga—Zn oxide semiconductor (IGZO) containing In (indium), Ga (gallium), and Zn (zinc). It is preferable that the composition of the In—Ga—Zn oxide semiconductor be InGaZnO₄, in which In:Ga:Zn=1:1:1. A reason for this is that as a feature of the oxide semiconductor of this composition, the oxide semiconductor of this composition shows a tendency to increase in electron mobility with an increase in electrical conductivity. Note, however, that proportions of In, Ga, and Zn in IGZO can be selected as appropriate.

The semiconductor layer 23D may be composed of another oxide semiconductor instead of IGZO. For example, the semiconductor layer 23D may be composed of indium oxide, zinc oxide, tin oxide, an In—Zn oxide (IZO), a Zn—Ti oxide (ZTO), a Cd—Ge oxide, a Cd—Pb oxide, or other oxide semiconductors.

The TFT 23 illustrates an example of a bottom-gate structure in which the gate electrode 23A is placed below the semiconductor layer 23D. The TFT 23 may have a top-gate structure in which the gate electrode 23A is placed above the semiconductor layer 23D. Further, the TFT 23 also illustrates an example of a top-contact structure in which the source electrode 23B and the drain electrode 23C are placed above the semiconductor layer 23D. The TFT 23 may have a bottom-contact structure in which the source electrode 23B and the drain electrode 23C are placed below the semiconductor layer 23D.

In a case where the semiconductor layer 23D is composed almost exclusively of IGZO, which is superior in electron mobility, a writing process of writing an image based on a video signal to the liquid crystal panel 11 by applying a positive gate voltage to the gate electrode 23A and thereby driving the TFT 23 can be performed at a high frequency. Performing the writing process at a higher frequency leads to an increase in the number of video frames that are displayed on the liquid crystal panel 11 per unit time, with the result that a picture is smoothly displayed. A mode of driving of the TFT 23 is expressed by using Hz as a unit of the number of times the writing process is executed per second. A mode of driving of the TFT 23 in which the writing process is performed at a relatively high frequency is hereinafter referred to as “high-frequency driving”.

In a case where the semiconductor layer 23D is composed almost exclusively of IGZO, the value of resistance of the semiconductor layer 23D in a state where the positive gate voltage is not applied to the gate electrode 23A is advantageously higher and a leak current that flows through the channel region 23D1 is advantageously much smaller than they are in a case where the semiconductor layer 23D is composed almost exclusively of amorphous silicon.

Specifically, in a case where the semiconductor layer 23D is composed almost exclusively of amorphous silicon, the leak current that flows through the channel region 23D1 is produced when the state where the positive gate voltage is not applied to the gate electrode 23A continues. This causes a gradual decrease in a pixel potential applied to the pixel electrode 24. For the avoidance of this, even if a still image or other images are displayed on the liquid crystal panel 11, the positive gate voltage needs to be applied to the gate electrode 23A several tens of times in one second so that the luminance of the image on the liquid crystal panel 11 can be retained. In this regard, in a case where the semiconductor layer 23D is composed almost exclusively of IGZO, the leak current that flows through the channel region 23D1 is much smaller than it is in a case where the semiconductor layer 23D is composed almost exclusively of amorphous silicon, so that it is hard for the pixel potential applied to the pixel electrode 24 to decrease. For this reason, in a case where the semiconductor layer 23D is composed almost exclusively of IGZO, an image written to the liquid crystal panel 11 is retained for a given length of time even when the state where the positive gate voltage is not applied to the gate electrode 23A continues, i.e. even when a state where a negative gate voltage is applied is retained. Such a process of retaining the state where the negative gate voltage is applied to the gate electrode 23A is referred to a retention process.

The aforementioned high-frequency driving is a mode of driving of the TFT 23 in which the writing process and the retention process are repeated at high frequencies. Further, a mode of driving of the TFT 23 in which a still image is displayed and the frequency of execution of the writing process is lower than it is in the high-frequency driving is hereinafter referred to as “low-frequency driving”. The low-frequency driving of the TFT 23 is enabled especially in a case where the semiconductor layer 23D is composed almost exclusively of IGZO. In the present embodiment, the low-frequency driving is a state where the frequency of execution of the writing process ranges approximately from 1 Hz to less than 60 Hz, and the high-frequency driving is a state where the frequency of execution of the writing process is 60 Hz or higher. The control unit 50 of the liquid crystal display device 10, which will be described later, judges, depending on a situation where an image is written to the liquid crystal panel 11, whether to drive the TFT 23 at a low frequency or a high frequency and, according to the judgment, drives the TFT 23 at a low frequency or a high frequency.

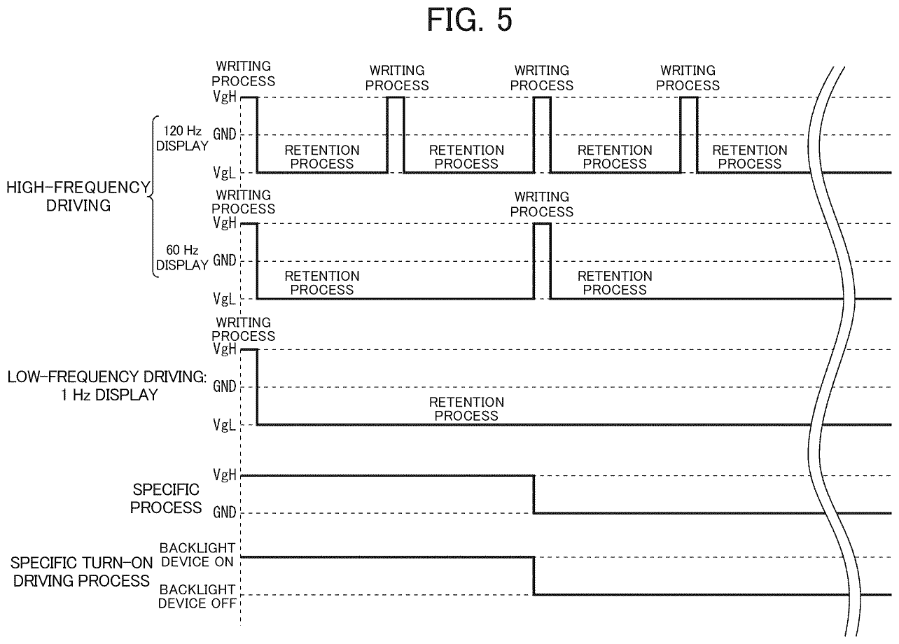

High-frequency control and low-frequency control of the TFT 23 are described in detail with reference to FIG. 5. In FIG. 5, VgH denotes the positive gate voltage that is applied to the gate electrode 23A for the writing process, and VgL denotes the negative voltage that is applied to the gate electrode 23A for the retention process. Further, GND denotes a ground potential (0 V). VgH is set, for example, to +20 V. VgL is set to be lower than GND, for example, to −10 V. The control unit 50, which will be described later, of the liquid crystal display device 10 includes a power supply circuit 52 that generates, based on a power supply given from an outside source, the positive gate voltage for the writing process and the negative gate voltage of the retention process.

First, an example of 120 Hz display in which the writing process is executed at a frequency of 120 times in one second is described. The positive gate voltage is applied to the gate electrode 23A of the TFT 23 according to the writing process. Then, by the time that the writing process is performed next, the negative gate voltage is applied to the gate electrode 23A according to the retention process. In the example of 120 Hz display, the writing process and the retention process are repeatedly executed at a frequency of 120 times in one second.

In example of 60 Hz display in which the writing process is executed at a frequency of 60 times in one second, the frequency of the writing process drops as much as 50 percent of the frequency of the writing process in the example of 120 Hz display. For this reason, as shown in FIG. 5, in the case of 60 Hz display, a period of time during which the retention process is performed per unit time is longer than it is in the case of 120 Hz display. That is, the lower the frequency of execution of the writing process becomes, the higher the proportion of the state where the negative gate voltage is applied to the gate electrode 23A becomes. Each of the examples of 120 Hz display and 60 Hz display in which the writing process and the retention process are performed several tens of times or more in one second is an example of the high-frequency driving. Although not illustrated, the high-frequency driving may include a case such as 240 Hz display where the writing process is performed at a frequency higher than 120 Hz.

FIG. 5 shows, as an example of the low-frequency driving, an example of 1 Hz display in which the writing process is executed at a frequency of 1 time in one second. In a case where the low-frequency driving is performed, the frequency of execution of the writing process becomes overwhelmingly lower than it is in a case where the high-frequency driving is performed, so that a period of time during which the retention process is performed comes to occupy most of unit time. That is, as shown in FIG. 5, in a case where the low-frequency driving is performed, the state where the negative gate voltage is applied to the gate electrode 23A comes to occupy a large proportion. In a case where a period of time during which an image that is displayed on the liquid crystal panel 11 is not refreshed, such as a case where a still image or other images are displayed on the liquid crystal panel 11, the frequency of execution of the writing process may be low, with the result that the low-frequency driving is performed. The lower the frequency of the writing process is made by such low-frequency driving, the lower the power consumption of the liquid crystal display device 10 becomes. Further, the longer the period of execution of the low-frequency driving becomes, the lower the power consumption of the liquid crystal display device 10 becomes.

An effect of stray light on the TFT 23 is described here with reference to FIG. 4. Although not illustrated in FIG. 4, the aforementioned backlight device 12 is placed at the back of the glass substrate 211 (i.e. at a side opposite to the side on which the TFT 23 is disposed). Most of light L1 emitted by the backlight device 12 and traveling through the glass substrate 211 toward the TFT 23 is reflected by the gate electrode 23A, which is a metal layer, and does not fall on the semiconductor layer 23D. Meanwhile, a portion of light L2 entering the TFT 23 without being reflected by the gate electrode 23A may be repeatedly reflected off surfaces of metal layers such as the source electrode 23B, the drain electrode 23C, and the gate electrode 23A and fall on the channel region 23D1 of the semiconductor layer 23D. Light such as the light L2 that is repeatedly reflected inside the TFT 23 is hereinafter referred to as “stray light”.

Applying the negative gate voltage to the gate electrode 23A in a state where the channel region 23D1 of the semiconductor layer 23D is irradiated with light causes a threshold voltage serving as a gate voltage at which the TFT 23 switches from an on-state to an off-state to shift in a minus direction. Such a shift in threshold voltage in a minus direction is called a negative shift in threshold. A mechanism by which a negative shift in threshold occurs is described. Irradiating the channel region 23D1 of the semiconductor layer 23D with light causes an electron-hole pair to be generated in the channel region 23D1. In a case where the negative gate voltage is applied to the gate electrode 23A, the hole of the electron-hole pair generated in the channel region 23D1 is attracted to a negative potential of the gate electrode 23A. The hole thus attracted is trapped at an interface between the semiconductor layer 23D and the gate insulating film 27 or at a level in the gate insulating film 27. The hole thus trapped behaves like a positive fixed charge, whereby a positive field from the hole is considered to cause the semiconductor layer 23D to easily come into an on-state, i.e. cause a negative shift in threshold. In a case where the low-frequency driving is performed, the state where the negative gate voltage is applied to the gate electrode 23A is dominant. Accordingly, in a case where the channel region 23D1 of the semiconductor layer 23D is irradiated with light based on the stray light in such a state, a negative shift in threshold tends to occur.

Another effect of the stray light on the TFT 23 is described. As mentioned above, in a state where a negative shift in threshold occurs, a hole is trapped at an interface between the semiconductor layer 23D and the gate insulating film 27 or at a level in the gate insulating film 27. Under such a situation, applying the positive gate voltage to the gate electrode 23A causes the hole trapped at the interface between the semiconductor layer 23D and the gate insulating film 27 or at the level in the gate insulating film 27 to be pushed away to a positive potential of the gate electrode 23A to migrate toward the semiconductor layer 23D. At this point in time, the channel region 23D1 of the semiconductor layer 23D is irradiated with light, whereby an electron-hole pair is generated in the channel region 23D1. Then, the hole trapped at the interface between the semiconductor layer 23D and the gate insulating film 27 or at the level in the gate insulating film 27 is attracted to the free electron of the electron-hole pair generated in the channel region 23D1. That is, irradiating the channel region 23D1 of the semiconductor layer 23D with light in a state where the positive gate voltage is applied to the gate electrode 23A encourages the hole trapped at the interface between the semiconductor layer 23D and the gate insulating film 27 or at the level in the gate insulating film 27 to migrate toward the channel region 23D1 of the semiconductor layer 23D. The hole having migrated to the channel region 23D1 loses an electric charge by combining with a free electron in the channel region 23D1. This causes the threshold voltage to shift (recover) in a plus direction toward an initial value that it assumed before the negative shift in threshold. Such recovery of the threshold voltage is called a positive shift in threshold.

The inventor of the present application focused attention especially on such a positive shift in threshold and intentionally created a situation where light based on stray light falls on the channel region 23D1 of the semiconductor layer 23D in a state where the positive gate voltage is applied to the gate electrode 23A. Providing such a situation in a timely manner causes a positive shift in threshold of the TFT 23 subjected to a negative shift in threshold by the low-frequency driving, bringing about improvement in characteristic of the TFT 23. That is, the TFT 23 is subjected to the low-frequency driving for a longer period of time, and the frequency of execution of the writing process in the low-frequency driving is further reduced.

The contents of the specific process and the specific turn-on driving process, which are executed by the control unit 50 of the liquid crystal display device 10, are described with reference to FIG. 5. A specific process execution process is executed in a case where the execution thereof is determined by the after-mentioned specific process execution determination process, which is executed by the control unit 50. Further, the specific turn-on driving process is executed in synchronization with the specific process.

As shown in FIG. 5, the specific process is a process of continuously applying the positive gate voltage to the gate electrode 23A of the TFT 23 and then finishing applying the positive gate voltage. In the present embodiment, the duration of the continuous application of the positive gate voltage to the gate electrode 23A in the specific process ranges approximately from 1/60 second to one second. After the positive gate voltage has been continuously applied to the gate electrode 23A for a predetermined length of time, the application of the positive gate voltage is ended. According to this, a potential at the gate electrode 23A then shifts to the ground potential.

As shown in FIG. 5, the specific turn-on driving process is a process of, during execution of the specific process, driving the backlight device 12 to glow at least in a predetermined period of time during which the positive gate voltage is continuously applied to the gate electrode 23A of the TFT 23. As the specific turn-on driving process, the after-mentioned control unit 50 sends, to a backlight control circuit 54 of the control unit 50, an instruction to turn on the LEDs 40. Upon receiving this instruction, the backlight control circuit 54 turns on the LEDs 40. This drives the backlight device 12 to glow.

Performing the specific turn-on driving process in synchronization with the specific process makes it easy for stray light based on light emitted by the backlight device 12 to be generated in a period during which the positive gate voltage is continuously applied to the gate electrode 23A. This makes it easy for light based on the stray light to fall on the channel region 23D1 of the semiconductor layer 23D in a state where the positive gate voltage is applied to the gate electrode 23A, making it easy for a positive shift in threshold to occur. This makes it easy to recover the threshold voltage of the TFT 23.

Note that FIG. 5 shows an example in which over the duration of the application of the positive gate voltage to the gate electrode 23A of the TFT 23, the backlight device 12 is driven to glow and then the backlight device 12 is turned off. In addition to this, during execution of the specific process, the backlight device 12 may be driven by the specific turn-on driving process to glow at least in any part of a period during which the positive gate voltage is continuously applied to the gate electrode 23A of the TFT 23. Further, during execution of the specific process, the backlight device 12 may be driven by the specific turn-on driving process to glow both while the positive gate voltage is continuously applied to the gate electrode 23A of the TFT 23 and after the application of the positive gate voltage has been ended. That is, during execution of the specific process, the backlight device 12 needs only be driven to glow at least in the predetermined period of time during which the positive gate voltage is continuously applied to the gate electrode 23A of the TFT 23.

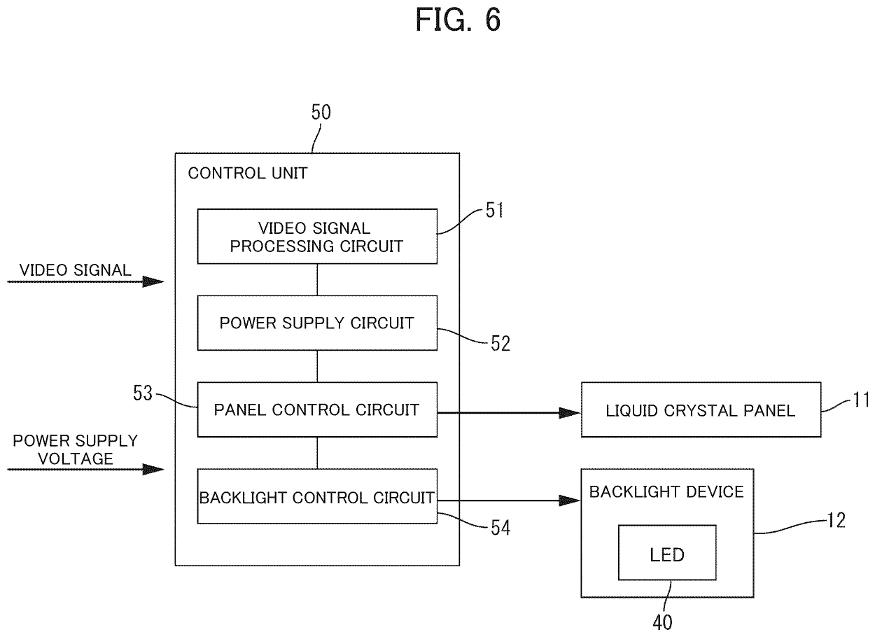

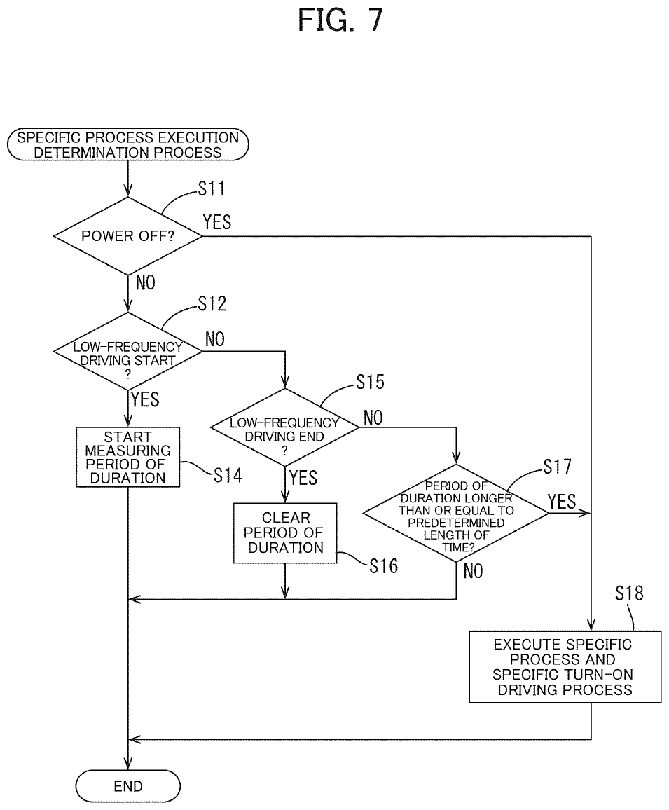

Next, a circuit configuration for controlling the driving of the liquid crystal panel 11 and the backlight device 12 is described with reference to FIG. 6. As shown in FIG. 6, the liquid crystal display device 10 includes the control unit 50, which controls the driving of the liquid crystal panel 11 and the backlight device 12. The control unit 50 includes a CPU that exercises overall control of the liquid crystal display device 10. Further, the control unit 50 includes a storage unit (not illustrated). The storage unit includes a ROM, a RAM, a flash memory, or other memories in which to store various parameters that the control unit 50 needs to in executing various programs. The storage unit has stored therein a program for causing the control unit 50 to execute a specific process execution determination process described later with reference to FIG. 7. The storage unit functions as an example of a process that executes the specific process execution determination process by decompressing the program stored in the storage unit.

The control unit 50 includes electric circuits such as a video signal processing circuit 51, a panel control circuit 53, and the backlight control circuit 54 that send driving signals (e.g. driving currents) to the liquid crystal panel 11 and the backlight device 12 in accordance with instructions from the CPU. The video signal processing circuit 51 processes a video signal supplied from an external host system and outputs the video signal thus processed. The panel control circuit 53 writes, to the liquid crystal panel 11, an image based on the processed video signal outputted from the video signal processing circuit 51. In a case where the liquid crystal display device 10 includes a gate driver and a source driver for writing an image to the liquid crystal panel 11, the panel control circuit 53 controls driving of the gate driver and the source driver. The backlight control circuit 54 controls the LEDs 40 and thereby adjusts the amount of light that is emitted by the LEDs 40. In controlling the LEDs 40, the backlight control circuit 54 can perform, for example, PWM (pulse width modulation) light control. In a case where the liquid crystal display device 10 includes an LED driver that drives the LEDs 40, the backlight control circuit 54 controls driving of the LED driver. Further, the control unit 50 includes the power supply circuit 52, which generates and supplies, based on a power supply voltage given from an outside source, voltages that the liquid crystal panel 11 and the backlight device 12 need to be driven. In particular, the power supply circuit 52 generates the positive gate voltage (VgH) and the negative gate voltage (VgL) that are applied to the TFT 23. VgH and VgL thus generated are appropriately supplied to the gate electrode 23A of the TFT 23 of the liquid crystal panel 11 according to the frequency at which an image is written to the liquid crystal panel 11.

The specific process execution determination process, which is executed by the control unit 50 of the liquid crystal display device 10, is described with reference to FIG. 7. To the control unit 50, an interrupt signal generation circuit (not illustrated) is connected.

The interrupt signal generation circuit generates an interrupt signal every time a clock signal is inputted from a clock circuit (not illustrated) that outputs a clock signal of a fixed frequency. The control unit 50 executes the specific process execution determination process every time an interrupt signal is inputted from the interrupt signal generation circuit. The step of each process is hereinafter abbreviated as “S”.

Once the specific process execution determination process is started, the control unit 50 judges whether the liquid crystal display device 10 has been powered off (S11). This judgment is made based on a result of a judgment made by a detection unit, provided in the control unit 50, that can detect a supply situation of the power supply (i.e. an on/off-state of the power supply). In a case where the control unit 50 has judged that the liquid crystal display device 10 has been powered off (S11: YES), the control unit 50 instructs the panel control circuit 53 to execute the specific process shown in FIG. 5 and also instructs the backlight control circuit 54 to execute the specific turn-on driving process shown in FIG. 5 (S18). After that, the control unit 50 ends the specific process execution determination process.

Thus, in the present embodiment, the control unit 50 executes the specific process and the specific turn-on driving process in powering off the liquid crystal display device 10. In the liquid crystal display device 10, an image such as an afterimage may remain on the liquid crystal panel 11 because a display is not immediately cleared even when a user of the liquid crystal display device 10 has powered off the liquid crystal display device 10. Such a situation is referred to as “burn-in”. When the liquid crystal display device 10 is powered off, a discharge path of an electric charge retained in the pixel electrode 24 of the array substrate 21 may be cut off, so that a residual charge may be accumulated in the pixel electrode 24. This is one reason why burn-in occurs. This problem is generally addressed by, in powering off the liquid crystal display device 10, applying the positive gate voltage to all gate electrodes 23A, discharging electric charges of the pixel electrodes 24 by finishing applying the positive gate voltage, and then making the potentials of the pixel electrodes 24 uniform at the ground potential. The specific process is equivalent to executing the application of the positive gate voltage to all gate electrodes 23A.

Thus, in the present embodiment, the control unit 50 executes the specific process and the specific turn-on driving process in turning the power off. This makes it easy for light based on stray light generated based on light emitted by the backlight device 12 to fall on the channel region 23D1 of the semiconductor layer 23D of the gate electrode 23A in a state where the positive gate voltage is applied to the gate electrode 23A. This makes it easy for a positive shift in threshold to occur, bringing about recovery of the threshold voltage of the TFT 23.

By executing the specific process and the specific turn-on driving process in powering off the liquid crystal display device 10, the control unit 50 can bring about recovery of the threshold voltage of the TFT 23 without hindering the use of the liquid crystal display device 10 by the user. Further, in addition to being a process that is performed to bring about recovery of the threshold voltage of the TFT 23, the specific process is a process that can also be executed for the prevention of burn-in. For this reason, the control unit 50 can immediately bring about recovery of the threshold voltage of the TFT 23 by applying, as the specific process, a process that has conventionally been performed for the prevention of burn-in in turning the power off and by executing the specific turn-on driving process in addition to this specific process. Accordingly, the liquid crystal display device 10 makes it possible to, without needing a major design change, appropriately provide an opportunity to recover the threshold voltage of the TFT 23.

The luminance at which the backlight device 12 is driven by the specific turn-on driving process to glow is described here. In general, the luminance of the backlight device 12 in a state where an image written to the liquid crystal panel 11 by performing the low-frequency driving or high-frequency driving of the TFT 23 is displayed (i.e. in a so-called image display mode in which an image is displayed on the liquid crystal panel 11) ranges approximately from 350 cd/m² to 1000 cd/m². In the present embodiment, in a case where the liquid crystal display device 10 is intended for indoor use, the luminance of the backlight device 12 in the image display mode is set to range approximately from 300 cd/m² to 700 cd/m². Further, in a case where the liquid crystal display device 10 is intended for outdoor use, the luminance of the backlight device 12 in the image display mode is set to be 1200 cd/m² or higher.

In the present embodiment, the luminance at which the backlight device 12 is driven by the specific turn-on driving process to glow is set to be lower than the luminance of the backlight device 12 in the case of a state where an image written to the liquid crystal panel 11 by performing the low-frequency driving or high-frequency driving, in which the writing process and the retention process are repeatedly performed, is displayed (i.e. a state of the image display mode). Specifically, the luminance at which the backlight device 12 is driven by the specific turn-on driving process to glow is set by the control unit 50 to range approximately from 1 cd/m² to 200 cd/m². This is intended to avoid giving the user of the liquid crystal display device 10 a feeling of incongruity as if there were a defect such as a failure in the liquid crystal display device 10 or the backlight device 12 due to the backlight device 12 being driven to glow at a high luminance in turning the power off. The liquid crystal display device 10 makes it possible to, by relatively lowering the luminance at which the backlight device 12 is driven by the specific turn-on driving process to glow, bring about recovery of the threshold voltage of the TFT 23 while reducing the possibility of giving the user a feeling of incongruity even when the specific turn-on driving process is executed.

FIG. 7 is referred to again. In a case where the control unit 50 has judged that the liquid crystal display device 10 has not been powered off (S11: NO), the control unit 50 judges whether the low-frequency driving has been started (S12). The control unit 50 can determine whether the low-frequency driving or the high-frequency driving is performed. Further, the control unit 50 includes a well-known timer counter. By counting up clock signals inputted from the aforementioned clock circuit, the timer counter can measure time elapsed since a predetermined point in time. The control unit 50 can use this timer counter to measure a period of duration, i.e. a period of time during which the low-frequency driving is continuously performed. Moreover, in a case where the measurement of the period of duration is not performed by the timer counter at the point in time of the judgment in S12 and the low-frequency driving is performed, the control unit 50 judges that the low-frequency driving has been started.

In a case where the control unit 50 has judged that the low-frequency driving has been started (S12: YES), the control unit 50 starts measuring the period of duration using the aforementioned timer counter (S14). After that, the control unit 50 ends the specific process execution determination process.

On the other hand, in a case where the control unit 50 does not judge that the low-frequency driving has been started (S12: NO), the control unit 50 judges whether the low-frequency driving has been ended and a transition to the high-frequency driving has been made (S15). In a case where the measurement of the period of duration is performed at the point in time of the judgment in S15 and the high-frequency driving is performed, the control unit 50 judges that the low-frequency driving has been ended. In a case where the control unit 50 has judged that the low-frequency driving has been ended and a transition to the high-frequency driving has been made (S15: YES), the control unit 50 clears to zero the period of duration stored in the timer counter (S16). After that, the control unit 50 ends the specific process execution determination process.

On the other hand, in a case where the control unit 50 is not measuring the period of duration and the high-frequency driving is performed or in a case where the control unit 50 is measuring the period of duration and the low-frequency driving is performed, the control unit 50 judges that the low-frequency driving has not been ended and a transition to the high-frequency driving has not been made (S15: NO). In this case, the control unit 50 judges, with reference to the timer counter, whether the period of duration being measured is longer than or equal to a predetermined length of time (S17). In a case where the period of duration being measured is shorter than the predetermined length of time or the high-frequency driving is executed, the control unit 50 judges that the period of duration being measured is not longer than or equal to the predetermined length of time (S17: NO), the control unit 50 ends the specific process execution determination process.

On the other hand, in a case where the period of duration being measured is longer than or equal to the predetermined length of time (S17: YES), the control unit 50 instructs the panel control circuit 53 to execute the specific process shown in FIG. 5 and also instructs the backlight control circuit 54 to execute the specific turn-on driving process shown in FIG. 5 (S18). After that, the control unit 50 ends the specific process execution determination process.

Thus, in the present embodiment, in a case where the period of duration of execution of the low-frequency driving is longer than or equal to the predetermined length of time, the control unit 50 executes the specific process and the specific turn-on driving process. In the present embodiment, the predetermined length of time is, for example, one hour. This predetermined length of time can be arbitrarily set by a designer of the liquid crystal display device 10 within the scope of suitability for recovery of the threshold of the TFT 23.

The case where the execution of the low-frequency driving continues for the predetermined length of time or longer is a situation where there tends to occur a negative shift in threshold of the TFT 23. Further, the case where the execution of the low-frequency driving continues for the predetermined length of time or longer is considered to be a situation where the user is not actively using the liquid crystal display device 10, such as a situation where a period of time during which an external operation is not performed on the liquid crystal display device 10 continues. By executing the specific process and the specific turn-on driving process in such a case, the control unit 50 makes it possible to, while avoiding as mush as possible hindering the use of the liquid crystal display device 10 by the user, positively shift, in a timely manner, a threshold of the TFT 23 subjected to a negative shift in threshold by continuing the low-frequency driving.

As noted above, a liquid crystal display device 10 includes a liquid crystal panel 11, a backlight device 12 that illuminates the liquid crystal panel 11 with light from behind, and a control unit 50 that controls driving of the liquid crystal panel 11 and driving of the backlight device 12. The liquid crystal panel 11 includes a TFT 23 including a semiconductor layer 23D containing an oxide semiconductor. The control unit 50 executes a writing process of writing an image based on a video signal to the liquid crystal panel 11 by applying a positive gate voltage to the TFT 23, a retention process of, in a state where a negative gate voltage is applied to the TFT 23, retaining the image written to the liquid crystal panel 11 by the writing process, a specific process of, at a predetermined timing, continuously applying the positive gate voltage to the TFT 23 and then finishing applying the positive gate voltage, and a specific turn-on driving process of, during execution of the specific process, driving the backlight device 12 to glow at least in a predetermined period of time during which the positive gate voltage is continuously applied to the TFT 23.

By executing the retention process after the writing process has been performed, the control unit 50 of the liquid crystal display device 10 can retain the image written to the liquid crystal panel 11 by the writing process. This allows the liquid crystal display device 10 to, in displaying a still image or other images, reduce the power consumption of the liquid crystal display device 10 by reducing the frequency of execution of the writing process. Note here that when the TFT 23 is kept in a state of continuously receiving photoirradiation with the stray light based on the light from the backlight device 12 in a state where the negative gate voltage is applied to the TFT 23, there undesirably occurs a negative shift in threshold, i.e. a shift in threshold voltage of the TFT 23 in a minus direction. Meanwhile, it is known that even if there occurs such a negative shift in threshold, applying the positive gate voltage to the TFT 23 and subjecting the TFT 23 to photoirradiation with the stray light causes the threshold voltage of the TFT 23 to undergo a change in a plus direction (positive direction) toward an initial value that it assumed before the negative shift in threshold had occurred (i.e. causes a positive shift in threshold). The liquid crystal display device 10 is configured such that during execution of the specific process, the backlight device 12 is driven by the specific turn-on driving process to glow at least in a predetermined period of time during which the positive gate voltage is continuously applied to the TFT 23. For this reason, the TFT 23 to which the positive gate voltage is being applied receives photoirradiation with the stray light, whereby a positive shift in threshold of the TFT 23 can be made. Accordingly, the liquid crystal display device 10 can positively shift, in a timely manner, a threshold of the TFT 23 subjected to a negative shift in threshold.

The control unit 50 may execute the specific process and the specific turn-on driving process in powering off the liquid crystal display device 10 (S11: NO, S18).

In this case, the control unit 50 executes the specific process and the specific turn-on driving process in powering off the liquid crystal display device 10. This makes it possible to, without hindering the use of the liquid crystal display device 10 by a user, recover the threshold of the TFT 23 subjected to the negative shift in threshold.

The control unit 50 may be able to execute both high-frequency driving in which the writing process and the retention process are repeated at high frequencies and low-frequency driving in which a frequency of execution of the writing process is lower than it is in the high-frequency driving and, in a case where a period of duration of execution of the low-frequency driving is longer than or equal to a predetermined length of time, may execute the specific process and the specific turn-on driving process (S17: YES, S18).

The case where the execution of the low-frequency driving continues for the predetermined length of time or longer is a situation where there tends to occur a negative shift in threshold of the TFT 23. Further, the case where the execution of the low-frequency driving continues for the predetermined length of time or longer is considered to be a situation where the user is not actively using the liquid crystal display device 10. By executing the specific process and the specific turn-on driving process in such a case, the control unit 50 can positively shift, in a timely manner, the threshold of the TFT 23 subjected to the negative shift in threshold.

The control unit 50 may cause the backlight device 12 to be lower in luminance during the specific turn-on driving process than it is in a case where the writing process and the retention process are executed (during an image display mode).

The case where the writing process and the retention process are executed (during the image display mode) is a situation where the image based on the video signal is written to the liquid crystal panel 11. In such a case, the control unit 50 drives the backlight device 12 to glow at such a predetermined luminance that viewability of the image is maintained. Meanwhile, in the specific turn-on driving process, the backlight device 12 needs only be driven to glow at such a luminance that the TFT 23 to which the positive gate voltage is being applied is subjected to a positive shift in threshold. Accordingly, the control unit 50 may cause the lighting device to be lower in luminance during the specific turn-on driving process than it is in a case where the writing process and the retention process are executed. This makes it possible to reduce power consumption in positively shifting the threshold of the TFT subjected to the negative shift in threshold. This also makes it possible to avoid giving the user a feeling of incongruity by driving the backlight device 12 to glow through the specific turn-on driving process.

The semiconductor layer 23D of the TFT 23 may contain an In—Ga—Zn oxide semiconductor.

In a case where the semiconductor layer 23D of the TFT 23 contains an In—Ga—Zn oxide semiconductor, the low-frequency driving, in which the frequency of execution of the writing process is lower than it is in the high-frequency driving, tends to become predominant over the high-frequency driving, in which the writing process and the retention process are repeated at high frequencies. This makes it easy to cause a negative shift in threshold of the TFT 23. The control unit 50 of the liquid crystal display device 10, which executes the specific process and the specific turn-on driving process in a case where such a TFT 23 is employed, can appropriately positively shift the threshold of the TFT 23 subjected to the negative shift in threshold.

### Details of Second Embodiment of the Present Disclosure

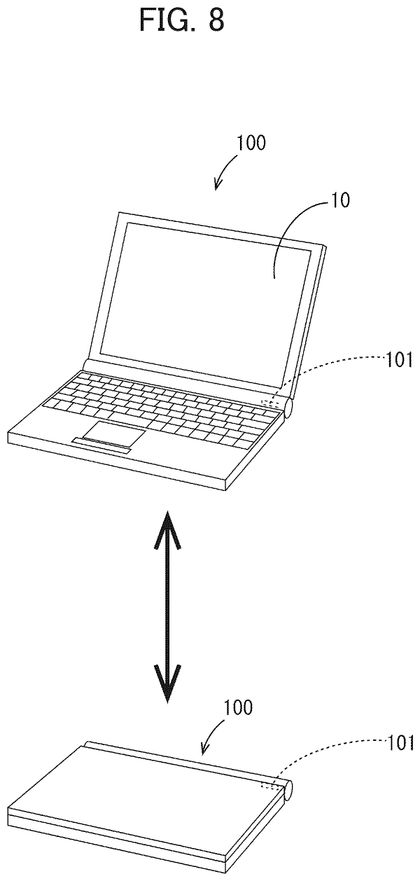

A second embodiment of the present disclosure is described with reference to FIGS. 8 to 10. In the second embodiment, components that are the same as those of the first embodiment are given identical reference signs, and a repeated description of structures, actions, and effects is omitted.

A status of use of the liquid crystal display device 10 is described with reference to FIG. 8. As shown in FIG. 8, the liquid crystal display device 10 may be mounted in a personal computer (PC) 100 and used as a display unit of the PC 100. In the second embodiment, the PC 100 is a well-known notebook personal computer (laptop personal computer) that has an integrated combination of the display unit and an operation unit such as a keyboard and a touch panel and that can be folded in half with the display unit and the operation unit facing inward. In the following description, a state where, as shown in the upper part of FIG. 8, the PC 100 is not folded in half and a user is able to visually recognize the display unit of the PC 100 constituted by the liquid crystal display device 10 is an “open state”. A state where, as shown in the lower part of FIG. 8, the PC 100 is folded in half and the user is unable to visually recognize the display unit of the PC 100 constituted by the liquid crystal display device 10 is a “closed state”. Situations where the PC 100 is used include at least both the open state and the closed state.

As shown in FIG. 8, the PC 100 contains an open-close sensor 101 that is a sensor that can detect whether the PC 100 is in the open state or the closed state. The open-close sensor 101 is, for example, a well-known magnetic sensor. The open-close sensor 101 may be a noncontact sensor such as an optical sensor. The open-close sensor 101 is not limited to being contained in the PC 100 but may be provided outside the PC 100. For example, the open-close sensor 101 may be a sensor that physically detects a protrusion provided at a given position placed inside in a case where the PC 100 is folded in half. The open-close sensor 101 may be any type of sensor that can detect whether the PC 100 is in the open state or the closed state. The open-close sensor 101 is configured to be able to output, as a signal, information indicating whether the PC 100 is in the open state or the closed state. This signal that the open-close sensor 101 outputs is hereinafter referred to as “status-of-use signal”.

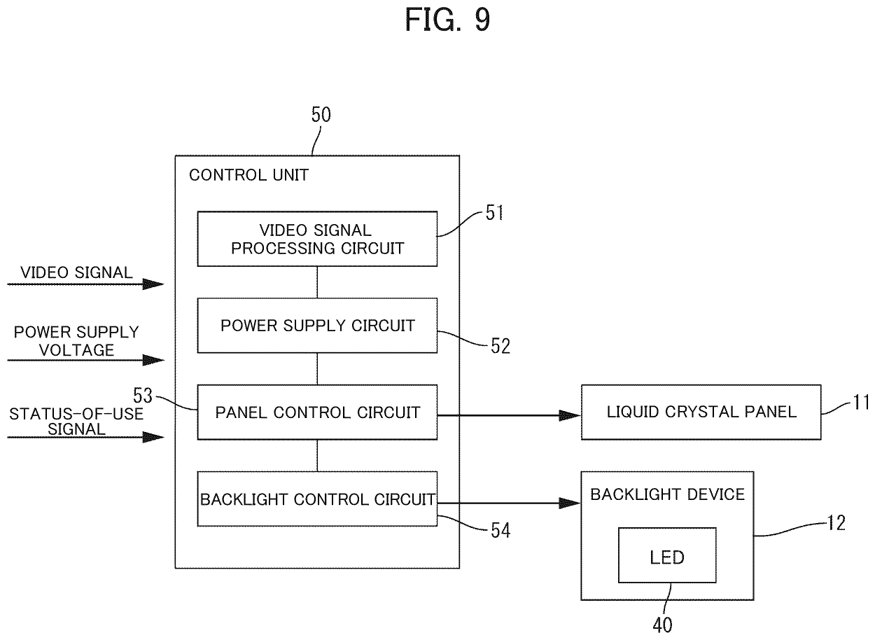

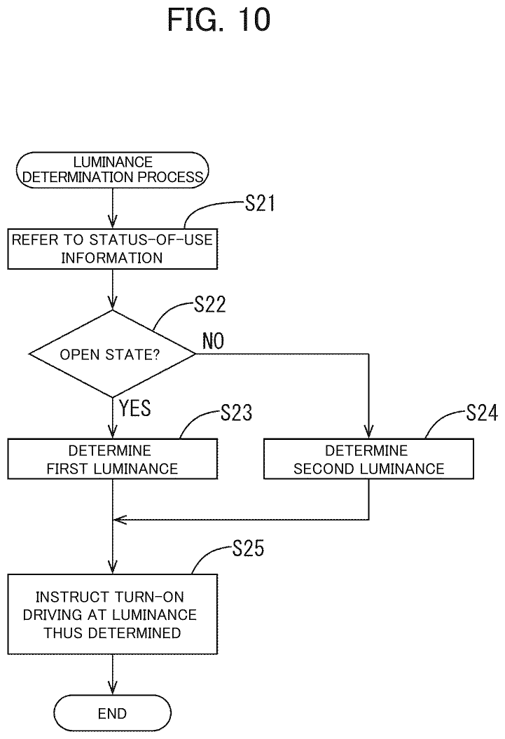

In the second embodiment, as shown in FIG. 9, the control unit 50 is configured to be able to receive a status-of-use signal that the open-close sensor 101 outputs. This allows the control unit 50 to grasp whether the PC 100 is in the open state or the closed state. The storage unit of the control unit 50 has stored therein a program for causing the control unit 50 to execute a luminance determination process described later in FIG. 10. The storage unit functions as an example of a process that executes the luminance determination process by decompressing the program stored in the storage unit.

The luminance determination process that is executed by the control unit 50 is described with reference to FIG. 10. The control unit 50 executes the luminance determination process in a case where the process of S18 in the specific process execution determination process described earlier in FIG. 7 has been executed.

Once the luminance determination process is started, the control unit 50 refers to status-of-use information indicated by a status-of-use signal being sent from the open-close sensor 101 (S21). The control unit 50 judges whether the status-of-use information thus referred to indicates the open state (S22). In a case where the control unit 50 has judged that the status-of-use information indicates the open state (S22: YES), the control unit 50 determines a first luminance as the luminance at which the backlight device 12 is driven by the specific turn-on driving process to glow (S23). The first luminance is a luminance that is the same as the luminance at which the backlight device 12 is driven by the specific turn-on driving process to glow in the first embodiment. That is, the first luminance is a luminance that is lower than it is in a case where the writing process and the retention process are executed (during the image display mode).

Specifically, the first luminance ranges approximately from 1 cd/m² to 200 cd/m². The control unit 50 shifts the process to S25.

On the other had, in a case where the control unit 50 has judged that the status-of-use information indicates not the open state but the closed state (S22: NO), the control unit 50 determines a second luminance as the luminance at which the backlight device 12 is driven by the specific turn-on driving process to glow (S24). The control unit 50 shifts the process to S25. In the second embodiment, the second luminance is a luminance that is higher than the first luminance. That is, the second luminance is a luminance that is higher than 1 cd/m² to 200 cd/m². In the present embodiment, the second luminance is approximately 300 cd/m². The second luminance needs only be higher than the first luminance. Further, the second luminance may be higher or lower than a luminance that is set in case where the writing process and the retention process are executed (during the image display mode).

In the case of the open state, the liquid crystal display device 10 in the PC 100 is in a state of being able to be visually recognized by the user. For example, in a case where the PC 100 is in the open state, the powering off of the PC 100 causes the backlight device 12 of the liquid crystal display device 10 to be driven by the specific turn-on driving process to glow at a high luminance. In this case, the user of the PC 100 may be given a feeling of incongruity as if there were a defect in the backlight device 12, the liquid crystal display device 10, or the PC 100. For this reason, in a case where the PC 100 is in the open state, the control unit 50 performs the process of S23 to determine the first luminance, which makes it hard for the user to be given a feeling of incongruity, as the luminance at which the backlight device 12 is driven by the specific turn-on driving process to glow. Since the first luminance is a relatively low luminance, the liquid crystal display device 10 makes it possible to bring about recovery of the threshold voltage of the TFT 23 without giving the user a feeling of incongruity.

On the other hand, in the case of the closed state, the liquid crystal display device 10 in the PC 100 is in a state of not being visually recognized by the user.

For this reason, it is conceivable that even when the backlight device 12 is driven by the specific turn-on driving process to glow at a high luminance, it may be hard for the user to be given a feeling of incongruity. The PC 100 may also be brought into the closed state in a case where the PC 100 is powered off or a case where the PC 100 remains unused for a long period. Accordingly, in a case where the PC 100 is in the closed state, the control unit 50 performs the process of S24 to determine the second luminance, which is higher than the first luminance, as the luminance at which the backlight device 12 is driven by the specific turn-on driving process to glow. This allows the liquid crystal display device 10 to effectively make a positive shift in threshold of the TFT 23 by actively generating stray light.

After that, the control unit 50 instructs the backlight control circuit 54 to drive the backlight device 12 in the specific turn-on driving process to glow at the luminance determined in S23 or S24 (S25). The backlight control circuit 54 drives the backlight device 12 in the specific turn-on driving process to glow at the first luminance or the second luminance as instructed by the process of S25. The control unit 50 ends the luminance determination process.

As noted above, the control unit 50 may determine a luminance of the backlight device 12 during the specific turn-on driving process according to a result of a judgement made on a status of use of the liquid crystal display device 10.

The liquid crystal display device 10 is used in various situations. The control unit 50 determines the luminance of the backlight device 12 in the specific turn-on driving process according to various statuses of use of the liquid crystal display device 10, and executes the specific turn-on driving process at the luminance thus determined. Accordingly, the liquid crystal display device 10 makes it possible to avoid giving the user a feeling of incongruity by driving the backlight device 12 to glow through the specific turn-on driving process.

### Other Embodiments

The present disclosure is not limited to the embodiments described above with reference to the drawings. The following embodiments may be included in the technical scope of the present disclosure; furthermore, various changes other than the following changes can be made without departing from the scope.
(1) In each of the foregoing embodiments, the control unit 50 executes the specific process and the specific turn-on driving process as processes that are executed when the supply of power from an outside source has been shut off and as processes that are executed in a case where the low-frequency driving has continued for the predetermined length of time or longer. Note here that as a display mode of the liquid crystal display device 10, a sleep mode in which the display of an image on the liquid crystal panel 11 is turned off for the purpose of saving power in the liquid crystal display device 10 may be provided in addition to the image display mode in which an image written to the liquid crystal panel 11 by performing the low-frequency driving or the high-frequency driving is displayed. The control unit 50 may execute the specific process and the specific turn-on driving process, for example, as processes by which the liquid crystal display device 10 makes a transition from the image display mode to the sleep mode.
(2) The control unit 50 may execute the specific process and the specific turn-on driving process at a timing arbitrarily selected by the user. For example, the liquid crystal display device 10 may include a predetermined operation unit that the user can operate, and in a case where a predetermined operation has been performed on the operation unit, the control unit 50 may execute the specific process and the specific turn-on driving process.
(3) As a status of use of the liquid crystal display device 10, an attitude of the liquid crystal display device 10 may be considered. Specifically, in a case where the liquid crystal display device 10 is used as a display unit of a smartphone or a tablet terminal, the liquid crystal display device 10 may include a sensor, such as an acceleration sensor connected to the control unit 50, that can sense a motion or a tilt of the liquid crystal display device 10. For example, in a case where the liquid crystal display device 10 is in a state where the front thereof faces downward, it is conceivable that even when the backlight device 12 is driven by the specific turn-on driving process to glow at a high luminance, the glow of the backlight device 12 may be so inconspicuous that it is hard for the user to be given a feeling of incongruity. For this reason, in a case such as a case where the front of the liquid crystal display device 10 faces downward, the luminance at which the backlight device 12 is driven in the specific turn-on driving process to glow may be set to be a high luminance. Further, for example, in a case where the liquid crystal display device 10 is in a state where the front thereof faces upward, when the backlight device 12 is driven by the specific turn-on driving process to glow at a high luminance, the glow of the backlight device 12 is easily visually recognized by the user. For this reason, in a case such as a case where the front of the liquid crystal display device 10 faces upward, the luminance at which the backlight device 12 is driven in the specific turn-on driving process to glow may be set to be a low luminance. The sensor that can sense a motion or a tilt of the liquid crystal display device 10 may be one that is externally connected to the liquid crystal display device 10. In this case, the control unit 50 may receive, from this sensor, information indicating the attitude of the liquid crystal display device 10 and determine, according to the information thus received, the luminance at which the backlight device 12 is driven in the turn-on driving process to glow.
(4) As a status of use of the liquid crystal display device 10, the brightness of an area around the liquid crystal display device 10 may be considered. Specifically, the liquid crystal display device 10 may include an illuminance sensor connected to the control unit 50. It is assumed here that the illuminance sensor is a well-known one that can sense the brightness of the surrounding area. Moreover, the control unit 50 may determine, according to information indicating the brightness of the area around the liquid crystal display device 10 as indicated by this illuminance sensor, the luminance at which the backlight device 12 is driven in the specific turn-on driving process to glow. For example, in a case where the brightness of the area around the liquid crystal display device 10 is relatively high, it is conceivable that even when the backlight device 12 is driven by the specific turn-on driving process to glow at a high luminance, the glow of the backlight device 12 may be so inconspicuous that it is hard for the user to be given a feeling of incongruity. For this reason, in a case where the brightness of the area around the liquid crystal display device 10 is relatively high, the luminance at which the backlight device 12 is driven in the specific turn-on driving process to glow may be set to be a high luminance. Further, for example, in a case where the brightness of the area around the liquid crystal display device 10 is relatively low, when the backlight device 12 is driven by the specific turn-on driving process to glow at a high luminance, the glow of the backlight device 12 is easily visually recognized by the user. For this reason, in a case where the brightness of the area around the liquid crystal display device 10 is relatively low, the luminance at which the backlight device 12 is driven in the specific turn-on driving process to glow may be set to be a low luminance. The illuminance sensor is not limited to being contained in the liquid crystal display device 10 but may be externally connected to the liquid crystal display device 10. In this case, the control unit 50 may receive, from the illuminance sensor, information indicating the brightness of the area around the liquid crystal display device 10 and determine, according to the information thus received, the luminance at which the backlight device 12 is driven in the turn-on driving process to glow.
(5) The liquid crystal display device 10 may be configured to be able to regulate, in accordance with a user's predetermined operation, the luminance at which the backlight device 12 is driven in the specific turn-on driving process to glow.
(6) Although, in each of the foregoing embodiments, the backlight device 12 is of a direct-lit type in which a light source is placed at the back of the liquid crystal panel 11, the backlight device 12 may be of a unilateral edge-lit type in which a light source is placed at one end of the back of the liquid crystal panel 11. Alternatively, the backlight device 12 may be of a bilateral edge-lit type in which light sources are placed at both ends of the back of the liquid crystal panel 11.
(7) In addition to the blue LEDs, red LEDs that emit red light and green LEDs that emit green light may be used as light sources of the backlight device 12. Further, a type of light source (such as a laser light source or an organic EL (electroluminescence)) other than an LED may be used as a light source of the backlight device 12.
(8) The steps of the specific process execution determination process and the luminance determination process of the liquid crystal display device 10 are not limited to an example in which they are executed by the CPU of the control unit 50 of the liquid crystal display device 10. Some or all of the steps of the specific process execution determination process and the luminance determination process may be executed by another electronic device (such as an ASIC) or a CPU of a person computer that is an external device. The steps of the specific process execution determination process and the luminance determination process may be decentrally processed by a plurality of electronic devices (e.g. a plurality of CPUs). The order of the steps of the specific process execution determination process and the luminance determination process can be changed as appropriate, and steps may be omitted from and added to the steps of the specific process execution determination process and the luminance determination process. An aspect in which an operating system (OS) operating on the liquid crystal display device 10 performs part or the whole of the specific process execution determination process and the luminance determination process in accordance with instructions from the control unit 50 is encompassed in the scope of the present disclosure.
(9) The control unit 50 may be configured to wirelessly communicate with an external information device. Programs for executing the specific process execution determination process and the luminance determination process may be downloaded through wireless communication from a server connected to a network (not illustrated), i.e. sent as transmission signals, and stored in the storage unit of the control unit 50. In this case, the programs for executing the specific process execution determination process and the luminance determination process need only be stored in a non-transitory storage medium such as an HDD provided in the server.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device comprising:
a liquid crystal panel;
a lighting device that illuminates the liquid crystal panel with light from behind; and
a control unit that controls driving of the liquid crystal panel and driving of the lighting device,
wherein
the liquid crystal panel includes a TFT including a semiconductor layer containing an oxide semiconductor, and
the control unit executes
a writing process of writing an image based on a video signal to the liquid crystal panel by applying a positive gate voltage to the TFT,
a retention process of, in a state where a negative gate voltage is applied to the TFT, retaining the image written to the liquid crystal panel by the writing process,
a specific process of, at a predetermined timing, continuously applying the positive gate voltage to the TFT and then finishing applying the positive gate voltage, and
a specific turn-on driving process of, during execution of the specific process, driving the lighting device to glow at least in a predetermined period of time during which the positive gate voltage is continuously applied to the TFT.

2. The liquid crystal display device according to Claim 1, wherein the control unit executes the specific process and the specific turn-on driving process in powering off the liquid crystal display device.

3. The liquid crystal display device according to Claim 1, wherein the control unit is able to execute both high-frequency driving in which the writing process and the retention process are repeated at high frequencies and low-frequency driving in which a frequency of execution of the writing process is lower than it is in the high-frequency driving and, in a case where a period of duration of execution of the low-frequency driving is longer than or equal to a predetermined length of time, executes the specific process and the specific turn-on driving process.

4. The liquid crystal display device according to Claim 1, wherein the control unit causes the lighting device to be lower in luminance during the specific turn-on driving process than it is in a case where the writing process and the retention process are executed.

5. The liquid crystal display device according to

1. wherein the control unit determines a luminance of the lighting device during the specific turn-on driving process according to a result of a judgment made on a status of use of the liquid crystal display device.

6. The liquid crystal display device according to Claim 1, wherein the semiconductor layer of the TFT contains an In—Ga—Zn oxide semiconductor.
